(19) United States
(12) Patent Application Publication
(10) Pub. No.: US 2014/0152104 A1
(43) Pub. Date: Jun. 5, 2014

(54) Multi-Output Switching Regulator and Multi-Output Power Supply Method

(71) Applicant: Nien-Hui Kung, Hsinchu City (TW)

(72) Inventor: Nien-Hui Kung, Hsinchu City (TW)

(73) Assignee: Richtek Technology Corporation

(21) Appl. No.: 13/705,632

(22) Filed: Dec. 5, 2012

(51) Int. Cl. G05F 1/10

(52) U.S. Cl. CPC G05F 1/10
USPC 307/35

(57) ABSTRACT

The present invention discloses a multi-output switching regulator and a multi-output power supply method. The multi-output switching regulator includes: a power stage circuit for operating at least a power switch included therein and only one inductor included therein in response to a pulse width modulation (PWM) signal, thereby converting an input voltage to a converted voltage; a multiple outputs circuit for receiving the converted voltage to generate a plurality of output currents; a voltage detecting circuit for generating a feedback signal according to the converted voltage; and a PWM signal generation circuit for generating the PWM signal in response to the feedback signal.

### BACKGROUND OF THE INVENTION

1. Field of Invention

The present invention relates to a multi-output switching regulator and a multi-output power supply method; particularly, it relates to such multi-output switching regulator and multi-output power supply method for providing multiple output currents.

2. Description of Related Art

FIG. 1 shows a schematic diagram perspective view of a conventional multi-output switching regulator 1. As shown in FIG. 1, in the conventional multi-output switching regulator 1, the voltage detecting circuits 12 and 13 detect the voltages at the output nodes Vout1 and Vout2 to generate the feedback signals FB1 and FB2, respectively, and the PWM signal generation circuit 11 generates the PWM signals PWM1 and PWM2 according to the feedback signals FB1 and FB2, to operate two asynchronous boost switching power stage circuits 14 and 15 respectively, thereby converting an input voltage Vin to the output voltages at the output nodes Vout1 and Vout2. The conventional multi-output switching regulator 1 requires plural power stage circuits 14 and 15 to convert the input voltage Vin to the output voltages at plural output nodes Vout1 and Vout2. The power stage circuits 14 and 15 can be synchronous or asynchronous buck, boost, inverting, buck-boost or inverting-boost power stage circuits, as shown in FIGS. 2A-2J.

The above-mentioned prior art requires at least two power stage circuits to provide plural output currents Io1 and Io2, which is inconvenient and costs much higher.

In view of the above, to overcome the drawbacks in the prior art, the present invention proposes a multi-output switching regulator and a multi-output power supply method, which is capable of generating plural outputs and adjusting the distribution of the output current dynamically by sharing one single power stage (i.e., sharing only one single inductor).

### SUMMARY OF THE INVENTION

A first objective of the present invention is to provide a multi-output switching regulator.

A second objective of the present invention is to provide a multi-output power supply method.

To achieve the above and other objectives, from one perspective, the present invention provides a multi-output switching regulator, comprising: a power stage circuit for operating at least one power switch included therein and only one inductor included therein in response to a pulse width modulation (PWM) signal, to convert an input voltage to a converted voltage; a multi-output circuit for receiving the converted voltage and generating a plurality of output currents which are supplied to a plurality of output nodes; a voltage detecting circuit for generating a feedback signal according to the converted voltage; and a PWM signal generation circuit for generating the PWM signal in response to the feedback signal.

In one embodiment, when the converted voltage is lower than a predetermined level, at least one of the output currents is reduced.

In one embodiment, the multi-output switching regulator further comprises: a current control circuit for detecting each of the output currents and generating a corresponding current control signal, wherein the multi-output circuit generates the plurality of output currents according to the current control signals, respectively.

In the above-mentioned embodiment, preferably, a total amount upper limit is set for a total of the plurality of output currents, and the current control circuit dynamically assigns an individual upper limit to each of the output currents.

In above-mentioned embodiment, preferably, the multi-output circuit includes a plurality of load switches each of which is disposed on a path of a corresponding output current, and the plurality of load switches are operated in response to the current control signals so as to respectively adjust the corresponding output currents.

In one embodiment, an upper limit is set for at least one of the output currents, and the current control circuit adjusts the current control signal, such that: when the output current having the upper limit does not exceed the upper limit, the corresponding load switch is fully conductive, but if a fully conductive state of the load switch will cause the output current having the upper limit to exceed the upper limit, the load switch is partially conductive, to prevent the output current having the upper limit from exceeding the upper limit.

In one embodiment, the plurality of output currents include a main output current corresponding to a main load switch and at least a subordinate output current corresponding to a subordinate load switch, and the current control circuit adjusts the current control signals to keep the main output current at a corresponding required value in a higher priority than to keep the subordinate output current at a corresponding required value.

In above-mentioned embodiment, preferably, a total amount upper limit is set for a total of the plurality of output currents; when the main output current is kept at the corresponding required value, the current control circuit adjusts the current control signals to distribute a remain current obtained by subtracting the required value corresponding to the main output current from the total amount upper limit among the subordinate output currents.

In one embodiment, the multi-output switching regulator is a power bank.

From another perspective, the present invention provides a multi-output power supply method, comprising: operating a power stage circuit in response to a PWM signal to convert an input voltage to a converted voltage, and generating a plurality of output currents according to the converted voltage; and controlling the plurality of output currents individually so as to prevent a total amount of the plurality of output currents from exceeding a total amount upper limit.

In one embodiment, the multi-output power supply method further comprises: reducing at least one of the output currents when the converted voltage is lower than a predetermined level.

In one embodiment, the plurality of output currents include a main output current and at least a subordinate output current, and the multi-output power supply method further comprises: keeping the main output current at a corresponding required value in a higher priority than keeping the subordinate output current at a corresponding required value.

In the above-mentioned embodiment, the multi-output power supply method further comprises: when the main output current is kept at the corresponding desired value, distributing a remain current obtained by subtracting the required value corresponding to the main output current from the total amount upper limit among the subordinate output currents.

In one embodiment, the multi-output power supply method further comprises: dynamically assigning an individual upper limit to each of the output currents.

In the above-mentioned embodiment, the step of dynamically assigning an individual upper limit to each of the output currents includes: when one of the output currents does not reach its upper limit, raising the upper limit of another one of the output currents.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional multi-output switching regulator 1.

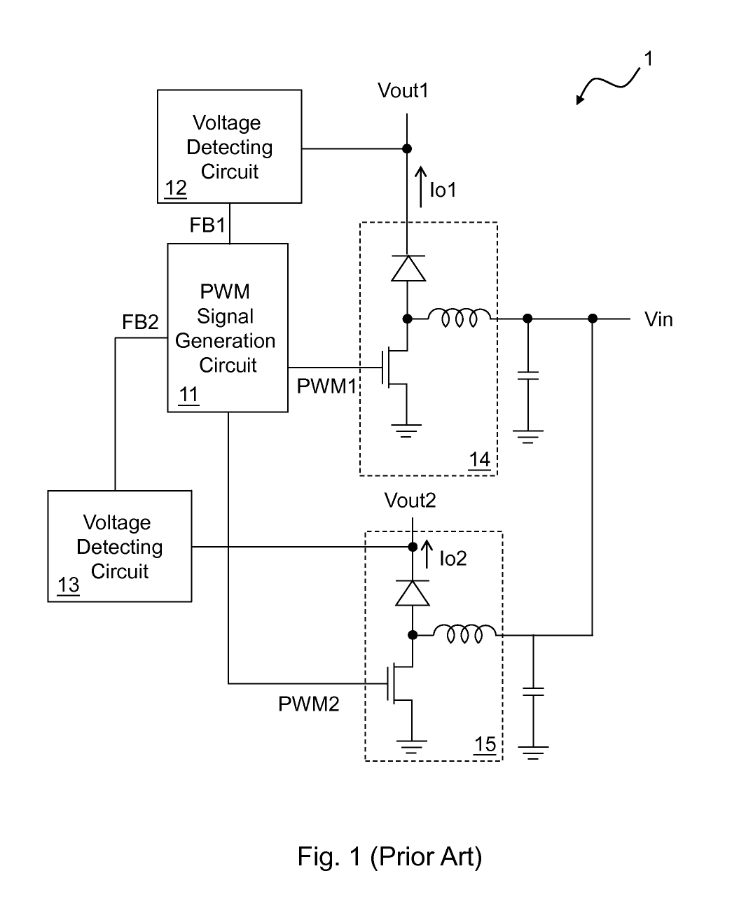

FIGS. 2A-2J show synchronous and asynchronous buck, boost, inverting, buck-boost and inverting-boost power stage circuits, respectively.

FIG. 3 shows a first embodiment of the present invention.

FIG. 4 shows a second embodiment of the present invention.

FIG. 5 shows a third embodiment of the present invention.

FIG. 6 shows a fourth embodiment of the present invention.

### DESCRIPTION OF THE PREFERRED EMBODIMENTS

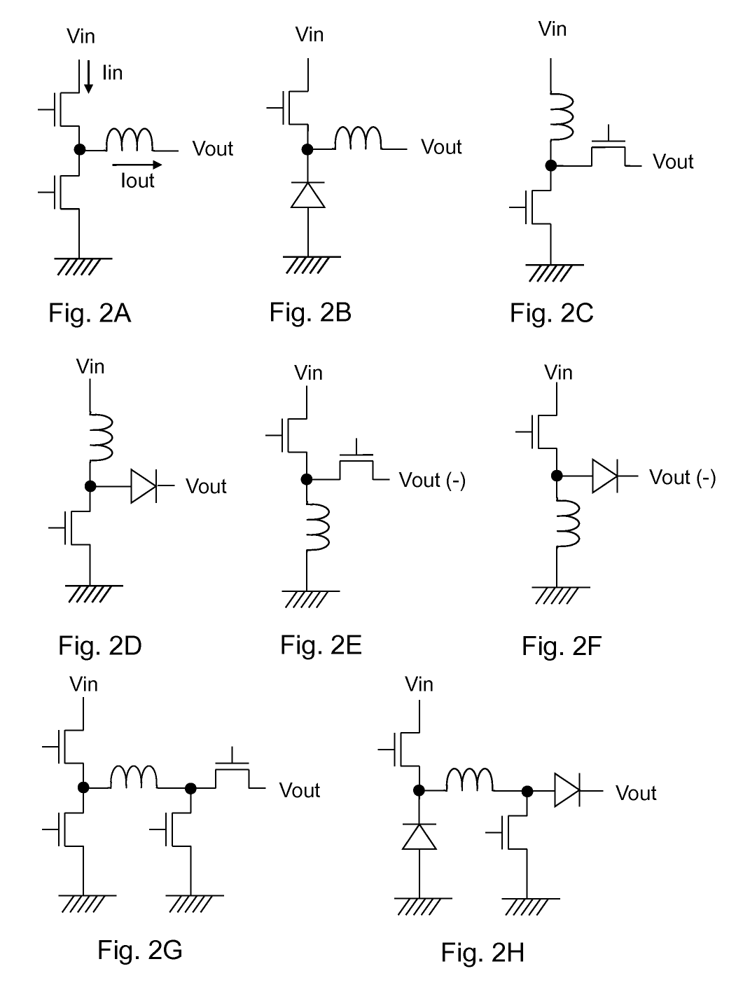

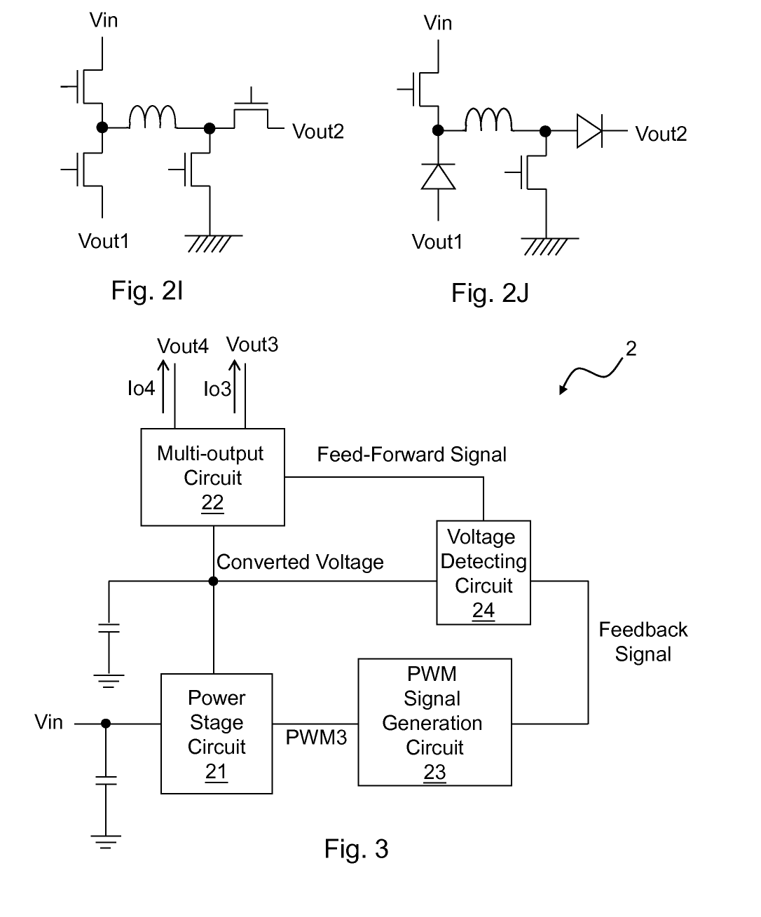

FIG. 3 shows a first embodiment of the present invention. As shown in FIG. 3, the multi-output switching regulator 2 comprises a power stage circuit 21, a multi-output circuit 22, a PWM signal generation circuit 23 and a voltage detecting circuit 24. In this embodiment, the power stage circuit 21 can be any type of synchronous or asynchronous buck, boost, inverting, buck-boost or inverting-boost power stage circuits, as shown in FIGS. 2A-2J. The power stage circuit 21 operates one or more power switches and only one single inductor therein (not shown in this figure but will be shown later in another embodiment) in response to a PWM signal PWM3, to convert an input voltage Vin to a converted voltage. The voltage detecting circuit 24 detects the converted voltage to generate a feedback signal. The PWM signal generation circuit 23 generates the PWM signal PWM3 in response to the feedback signal. The multi-output circuit 22 receives the converted voltage and generates plural output currents (for example but not limited to two output currents Io3 and Io4 shown in FIG. 3), which are supplied to two output nodes Vout3 and Vout4. Notably, the number of the plural output currents and the corresponding output nodes is not limited to two, and can be more than two.

In the above-mentioned first embodiment, if both of the output nodes Vout3 and Vout4 require large amounts of currents such that the total amount of the output currents Io3 and Io4 is too large, the level of the converted voltage will drop and possibly to an extent beyond the capacity of the power stage circuit 21. Under such circumstance, the present invention can detect whether the converted voltage is lower than a predetermined level, and if yes, at least one of the two output currents Io3 or Io4 is reduced.

Whether the converted voltage is lower than a predetermined level can be detected by, for example but not limited to, the follow approach: the output of the voltage detecting circuit 24 can be fed forward to the multi-output circuit 22 and compared with the predetermined level, and one of or both of the output currents Io3 and Io4 are controlled by the comparison result, as shown by FIG. 3. Certainly, the approach shown in FIG. 3 is only an example and whether the converted voltage is lower than a predetermined level can be detected by other ways not limited to generating the feed-forward signal by the voltage detecting circuit 24. Because the multi-output circuit 22 receives the converted voltage, the converted voltage (or its divided voltage) can be compared with the predetermined level (or a level proportional to it) in the interior of the multi-output circuit 22, and under such circumstance it does not require to receive the feed-forward signal generated by the voltage detecting circuit 24.

There are many ways to arrange the reduction of one or both of the output currents Io3 and Io4. For example, both of them can be reduced concurrently; or, while one of them is regarded as a main output current and kept at a corresponding required value in a higher priority, the other one of them is regarded as a non-main output current (hereinafter called “subordinate output current”) and is reduced. Take the latter case as an example, if the output node Vout4 is the output terminal that requires the power supply in a higher priority, the output current Io4 is the main output current. Thus, if the total amount of the two output currents Io3 and Io4 are too large (no matter due to the high requirement for which one of the output currents Io3 and Io4), the output current Io3 can be reduced in a higher priority while the output current Io4 is kept at the required value, thereby maintaining the main output current (i.e., the output current Io4 in this example) in a higher priority. It should be noted that the reduction of at least one of the two output currents when the level of the converted voltage is too low is preferred but not necessary. For example, if it can be certain that the total amount of the currents required by the two output nodes Vout3 and Vout4 is not beyond the capacity of the power stage circuit 21, the above-mentioned arrangement to reduce at least one of the two output currents is accordingly not required.

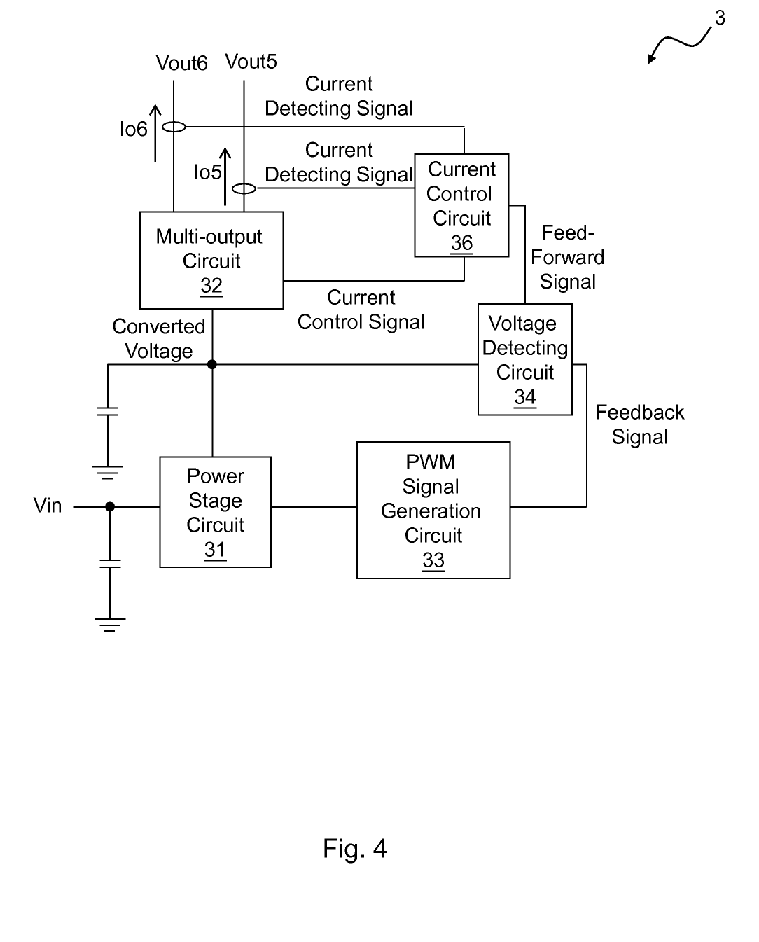

FIG. 4 shows a second embodiment of the present invention. As shown in FIG. 4, the multi-output switching regulator 3 comprises a power stage circuit 31, a multi-output circuit 32, a PWM signal generation circuit 33, a voltage detecting circuit 34 and a current control circuit 36. This embodiment is different from the first embodiment in that the multi-output switching regulator 3 of this embodiment further comprises a current control circuit 36. The current control circuit 36 detects the output currents Io5 and Io6, respectively, so as to generate the corresponding current control signals. The multi-output circuit 32 receives the converted voltage and generates plural output currents according to the current control signals. Like the first embodiment, this embodiment can detect whether the converted voltage is lower than a predetermined level (but this is not absolutely required). When the converted voltage is lower than a predetermined level, at least one of the two output currents Io5 or Io6 is reduced. The approach for detection is, for example but not limited to, as follow: the output of the voltage detecting circuit 34 can be fed forward to the current control circuit 36, thereby determining whether to reduce the output current. Certainly, as described previously in the first embodiment, the detection can be done by the multi-output circuit 32 to adjust the output currents in response to the converted voltage.

In a preferred embodiment, an upper limit is set for at least one of the plural output currents, and it is further preferable that the current control circuit 36 is capable of dynamically assigning or adjusting the upper limit. The current control circuit 36 adjusts the current control signals according to the current detecting signals and the above-mentioned upper limit, thus optimizing the distribution of the plural output currents. For instance, the plural output currents can be controlled to meet various practical needs as follows:
(1) Control mechanism 1: When none of the output current requirements exceed the corresponding upper limit of each output current, all output currents are provided to meet the corresponding requirements. When one of the output current requirement exceeds its upper limit, this output current is limited at its upper limit. In this control mechanism 1, the upper limit for each output current can be a fixed value or an adjustable value.
(2) Control mechanism 2: When one output current requirement does not exceed an initial upper limit, the upper limit of another output current can be raised up. For instance, the upper limit of a subordinate output current can be lowered down while the upper limit of a main output current can be raised up.
(3) Control mechanism 3: A total amount upper limit is set for a total of the plural output currents, and the current control circuit dynamically assigns the upper limit of each output current. The requirement for a main output current is fulfilled in a higher priority than the requirement for a subordinate output current. After the requirement for the main output current is fulfilled, the remain current obtained by subtracting the main output current from the total amount upper limit is distributed to other output currents.

It should be noted that the above-mentioned three control mechanisms are not exclusive to one another and are not limited to be adopted alone; two or more of them can be adopted in combination. For example, in the control mechanisms 1 and 2, a total amount upper limit can be set for the plural output currents, and the requirement for the main output current can be fulfilled in a higher priority.

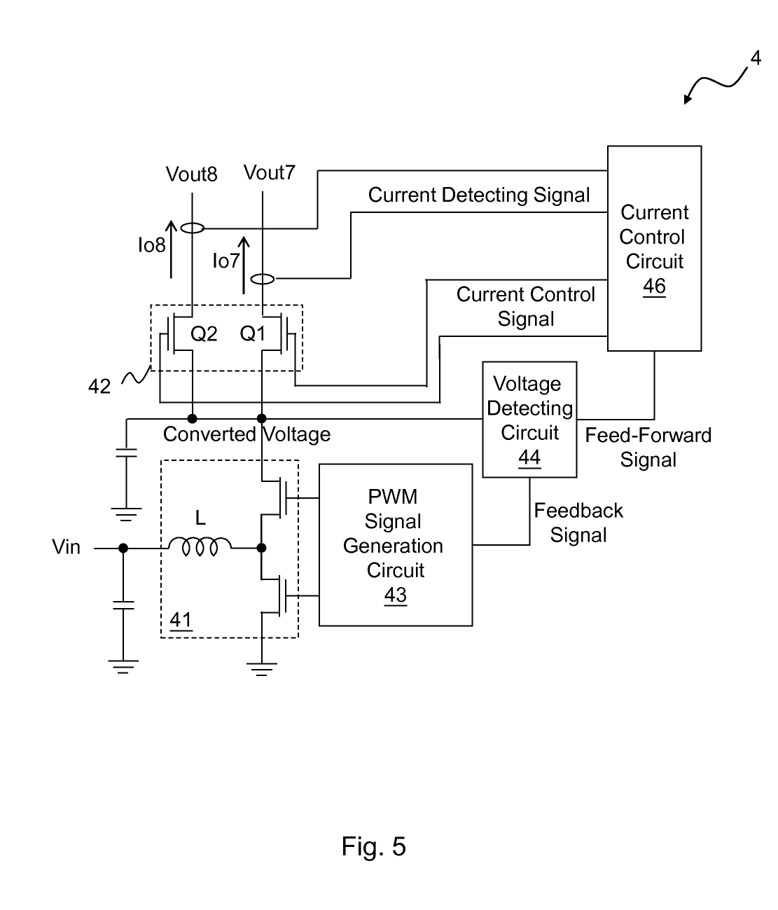

FIG. 5 shows a third embodiment of the present invention. As shown in FIG. 5, the multi-output switching regulator 4 comprises a power stage circuit 41, a multi-output circuit 42, a PWM signal generation circuit 43, a voltage detecting circuit 44 and a current control circuit 46. This embodiment illustrates a more detailed structure of the multi-output switching regulator 4. The power stage circuit 41 is, for example but not limited to, a synchronous boost power stage circuit as shown in FIG. 5. Notably, the power stage circuit 41 having only one single inductor L generates plural output currents Io7 and Io8 through the multi-output circuit 42. This embodiment illustrates an example as to how the plural output currents Io7 and Io8 are generated and controlled. The multi-output circuit 42 includes plural load switches Q1 and Q2, each of which is disposed at a path of a corresponding output current (for example, the load switch Q1 is coupled to the output node Vout7; the load switch Q2 is coupled to the output node Vout8). The load switches Q1 and Q2 are operated according to the current control signals, respectively. The current control signals control the respective gate voltages of the load switches Q1 and Q2 to determine whether the load switches Q1 and Q2 are fully conductive, such as adopting the above-mentioned control mechanisms 1, 2 and/or 3.

For example, if an upper limit is set for the output current Io7, the current control signal enables the corresponding load switch Q1 to be fully conductive when the requirement of the output current Io7 does not exceed its upper limit. In this case, the output current Io7 is controlled by the load circuit coupled to the output node Vout7. However, if the current detecting signal indicates that the output current Io7 will exceed its upper limit when the load switch Q1 is fully conductive, the current control signal controls the gate voltage of the load switch Q1 such that the load switch Q1 is only partially conductive. In this case, the output current Io7 is controlled by the load switch Q1, such that the output current Io7 does not exceed the upper limit. The output current Io8 can also be controlled in a similar way.

For another example, let us assume that the output current Io8 is the main output current while the output current Io7 is the subordinate output current. When the requirement of the output current Io7 does not exceed its initial upper limit, not only the load switch Q1 is fully conductive, but the upper limit of the main output current Io8 can also be raised up. In other words, when the main output current Io8 exceeds its initial upper limit but does not exceed the raised upper limit, the load switch Q2 is still enabled to be fully conductive.

For yet another example, let us assume that a total amount upper limit is set for the total of the output currents Io7 and Io8; the output current Io8 is the main output current while the output current Io7 is the subordinate output current. The load switch Q2 is kept fully conductive. The current control circuit 46 detects the output current Io8 and calculates the difference between the total amount upper limit and the output current Io8; this difference is distributed to the output current Io7. When this difference is higher than the requirement of the output node Vout7 for the output current Io7, the load switch Q1 is fully conductive. However, when this difference is lower than the requirement of the output node Vout7 for the output current Io7, this difference becomes the upper limit of the output current Io7. Thus, the current control signal controls the gate voltage of the load switch Q1 such that the load switch Q1 is only partially conductive. In this case, the output current Io7 is controlled by the load switch Q1 such that the output current Io7 does not exceed the upper limit.

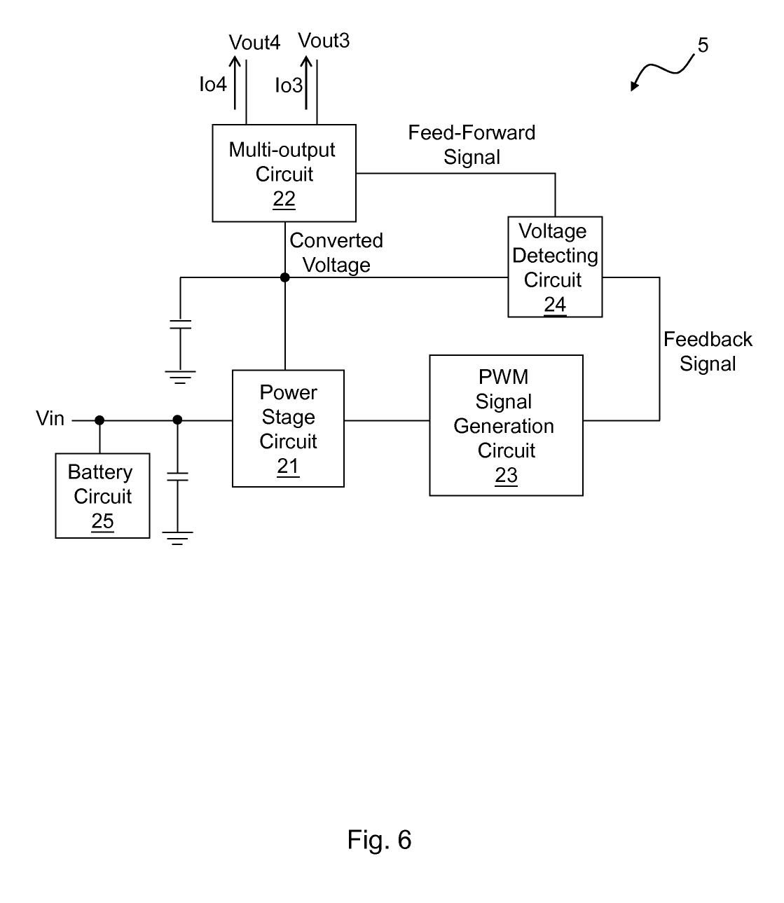

FIG. 6 shows a fourth embodiment of the present invention. In this embodiment, the multi-output switching regulator 5 is applied in, for example, a power bank. Thus, the input voltage Vin is provided by a battery circuit 25, as shown in FIG. 6. This embodiment is for illustrative purpose, but not for limiting the scope of the present invention, to explain that a battery is preferably included when the present invention is applied in a power bank; however, the present invention does not necessarily require the battery in other applications.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a circuit which does not substantially influence the primary function can be inserted between any two circuits in the shown embodiments, such as a switch. For another example, the the output current can be limited not for the reason beyond the capacity of the power stage circuit, but for any reason. For yet another example, although it is explained with reference to the embodiment of FIGS. 3 and 4 that at least one output current is lowered when the converted voltage is lower than a predetermined level, the approach can be applied to other embodiments where there is/is not current detecting circuit and where there is/is not current control circuit. In view of the foregoing, the spirit of the present invention should cover all such and other modifications and variations, which should be interpreted to fall within the scope of the following claims and their equivalents.

What is claimed is:

1. A multi-output switching regulator, comprising:
a power stage circuit for operating at least one power switch included therein and only one inductor included therein in response to a pulse width modulation (PWM) signal, to convert an input voltage to a converted voltage;
a multi-output circuit for receiving the converted voltage and generating a plurality of output currents which are supplied to a plurality of output nodes;
a voltage detecting circuit for generating a feedback signal according to the converted voltage; and
a PWM signal generation circuit for generating the PWM signal in response to the feedback signal.

2. The multi-output switching regulator of claim 1, wherein when the converted voltage is lower than a predetermined level, at least one of the output currents is reduced.

3. The multi-output switching regulator of claim 1, further comprising:
a current control circuit for detecting each of the output currents and generating a corresponding current control signal, wherein the multi-output circuit generates the output currents according to the current control signals, respectively.

4. The multi-output switching regulator of claim 3, wherein a total amount upper limit is set for a total of the plurality of output currents, and the current control circuit dynamically assigns an individual upper limit to each of the output currents.

5. The multi-output switching regulator of claim 3, wherein the multi-output circuit includes a plurality of load switches each of which is disposed on a path of a corresponding output current, and the plurality of load switches are operated in response to the current control signals so as to respectively adjust the corresponding output currents.

6. The multi-output switching regulator of claim 5, wherein an upper limit is set for at least one of the output currents, and the current control circuit adjusts the current control signal, such that: when the output current having the upper limit does not exceed the upper limit, the corresponding load switch is fully conductive, but if a fully conductive state of the load switch will cause the output current having the upper limit to exceed the upper limit, the load switch is partially conductive, to prevent the output current having the upper limit from exceeding the upper limit.

7. The multi-output switching regulator of claim 6, wherein the plurality of output currents include a main output current corresponding to a main load switch and at least one subordinate output current corresponding to a subordinate load switch, and the current control circuit adjusts the current control signals to keep the main output current at a corresponding required value in a higher priority than to keep the subordinate output current at a corresponding required value.

8. The multi-output switching regulator of claim 7, wherein a total amount upper limit is set for a total of the plurality of output currents; when the main output current is kept at the corresponding required value, the current control circuit adjusts the current control signals to distribute a remain current obtained by subtracting the required value corresponding to the main output current from the total amount upper limit among the subordinate output currents.

9. The multi-output switching regulator of claim 1, wherein the multi-output switching regulator is a power bank.

10. A multi-output power supply method, comprising:
operating a power stage circuit in response to a PWM signal to convert an input voltage to a converted voltage, and generating a plurality of output currents according to the converted voltage; and
controlling the plurality of output currents individually so as to prevent a total amount of the plurality of output currents from exceeding a total amount upper limit.

11. The multi-output power supply method of claim 10, further comprising:
reducing at least one of the output currents when the converted voltage is lower than a predetermined level.

12. The multi-output power supply method of claim 10, wherein the plurality of output currents include a main output current and at least a subordinate output current, and the multi-output power supply method further comprises:
keeping the main output current at a corresponding required value in a higher priority than keeping the subordinate output current at a corresponding required value.

13. The multi-output power supply method of claim 12, further comprising:
when the main output current is kept at the corresponding desired value, distributing a remain current obtained by subtracting the required value corresponding to the main output current from the total amount upper limit among the subordinate output currents.

14. The multi-output power supply method of claim 10, further comprising:
dynamically assigning an individual upper limit to each of the output currents.

15. The multi-output power supply method of claim 14, wherein the step of dynamically assigning an individual upper limit to each of the output currents includes:
when one of the output currents does not reach its upper limit, raising the upper limit of another one of the output currents.
